(19) United States
(12) Patent Application Publication
(10) Pub. No.: US 2016/0054977 A1
(43) Pub. Date: Feb. 25, 2016

(54) SYSTEMS AND METHODS WHICH JOINTLY PROCESS MOTION AND AUDIO DATA

(71) Applicant: Hillcrest Laboratories, Inc., Rockville, MD (US)

(72) Inventors: Charles W.K. GRITTON, Sterling, VA (US); Bryan COOK, Silver Spring, MD (US)

(21) Appl. No.: 14/833,434

(22) Filed: Aug. 24, 2015

Related U.S. Application Data
(60) Provisional application No. 62/040,579, filed on Aug. 22, 2014.

(51) Int. Cl. G06F 3/16; G06F 3/0346

(52) U.S. Cl. CPC G06F 3/167; G06F 3/0346

(57) ABSTRACT

Motion and audio data associated with an area or a user are sensed and processed jointly to achieve improved results as compared to utilizing only the motion or the audio data by themselves. Synergies between motion and audio are identified and exploited in devices ranging from cell phones to activity trackers to home entertainment and alarm systems.

### RELATED APPLICATION

This application is related to, and claims priority from, U.S. Provisional Patent Application Ser. No. 62/040,579, filed on Aug. 22, 2014, entitled “Audio and Motion Synergies”, the disclosure of which is incorporated here by reference.

### BACKGROUND

The present invention describes techniques, systems, software and devices, which can be used in conjunction with, or as part of, systems which gather information using sensors that leverage disparate channels of information to improve sensor output by, for example using data generated from one sensor and one channel of information to improve the quality of data output by another sensor for another, disparate channel of information, e.g., using audio information to improve an output of a motion sensor or vice-versa.

Technologies associated with the communication of information have evolved rapidly over the last several decades. Television, cellular telephony, the Internet and optical communication techniques (to name just a few things) combine to inundate consumers with available information and entertainment options. Taking television as an example, the last three decades have seen the introduction of cable television service, satellite television service, pay-per-view movies and video-on-demand. Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection processor even more tedious by forcing the user to repeatedly depress the up and down buttons to navigate the list or hierarchies. When selection skipping controls are available such as page up and page down, the user usually has to look at the remote to find these special buttons or be trained to know that they even exist. Accordingly, organizing frameworks, techniques and systems which simplify the control and screen interface between users and media systems as well as accelerate the selection process, while at the same time permitting service providers to take advantage of the increases in available bandwidth to end user equipment by facilitating the supply of a large number of media items and new services to the user have been proposed in U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

To navigate rich user interfaces like that described in the '432 patent application, new types of remote devices have been developed with are usable to interact with such frameworks, as well as other applications and systems. Various different types of remote devices can be used with such frameworks including, for example, trackballs, “mouse”-type pointing devices, light pens, etc. However, another category of remote devices which can be used with such frameworks (and other applications) is 3D pointing devices. The phrase “3D pointing” is used in this specification to refer to the ability of an input device to move in three (or more) dimensions in the air in front of, e.g., a display screen, and the corresponding ability of the user interface to translate those motions directly into user interface commands, e.g., movement of a cursor on the display screen. The transfer of data between the 3D pointing device and another device or system which consumes that data may be performed wirelessly or via a wire connecting the 3D pointing device to the other device or system. Thus “3D pointing” differs from, e.g., conventional computer mouse pointing techniques which use a surface, e.g., a desk surface or mousepad, as a proxy surface from which relative movement of the mouse is translated into cursor movement on the computer display screen. An example of a 3D pointing device can be found in U.S. Pat. No. 7,158,118 to Matthew G. Liberty (hereafter referred to as the '118 patent), the disclosure of which is incorporated here by reference. Note that although 3D pointing devices are used herein as one example of device which senses motion, the present application is not limited thereto and is intended to encompass all such motion sensing devices, e.g., activity tracking devices which are typically worn on a user's wrist, and indeed devices which sense parameters other than motion as will be described below.

The '118 patent describes 3D pointing devices which include, for example, one or two rotational sensors and an accelerometer. The rotational sensor(s) are used, as described in more detail below, to detect an angular rate at which the 3D pointing device is being rotated by a user. However, the output of the rotational sensor(s) does not perfectly represent the angular rate at which the 3D pointing device is being rotated due to, for example, bias (also sometimes referred to as “offset”) in the sensor(s)' outputs. For example, when the 3D pointing device is motionless, the rotational sensor(s) will typically have a non-zero output due to their bias. If, for example, the 3D pointing device is used as an input to a user interface, e.g., to move a cursor, this will have the undesirable effect of cursor drifting across the screen when the user intends for the cursor to remain stationary. Thus, in order to provide a 3D pointing device which accurately reflects the user's intended movement, estimating and removing bias from sensor output is highly desirable. Moreover other devices, in addition to 3D pointing devices, may benefit from being able to estimate and compensate for the bias of inertial sensors. Making this process more challenging is the fact that the bias is different from sensor to sensor and, even for individual sensors, is time-varying, e.g., due to changes in temperature.

Bias error associated with rotational sensors is merely one example of the more general paradigm that all sensors are imperfect and, therefore, output data which imperfectly reflects the portion of an environment which they are intended to measure. Thus the aforedescribed 3D pointing device imperfectly measures motion or movement of a user's hand which is holding the 3D pointing device. In the present specification “motion” can be considered to be one data channel that can be measured by a sensor or a number of different sensors.

Each individual sensor in a system typically individually senses one aspect of reality. Since such systems are generally concerned with sensing a local reality, i.e., one within some area surrounding the sensing system's disposed position. In this specification, this area will be referred to herein as a “scene”. The scene itself is typically quite complex and multi-dimensional but each sensor in the system only sees one dimension. For example, televisions being manufactured today may come with a number of different sensors including, for example, microphones and cameras which sense local sound and images in the area near the television.

Sensor errors are sometimes direct and sometimes indirect. A direct error is, for example, one where sensor bias or scale or resolution or noise corrupt the reading. An indirect error is, for example, one where the measurement is affected by other aspects of the scene. An example of an indirect error would be where the temperature affects the reading or one of the direct error drivers. For example, in the context of motion sensors described above, the temperature of a rotational sensor might affect the bias (or offset) of the sensor and thereby affect the output value of the sensor.

Compensation techniques can, for example, be derived to directly address the effects of both direct and indirect sensor errors. For example, in the context of direct sensor bias errors, as well as indirect sensor bias errors caused, e.g., by temperature, attempts have been made to directly compensate for such errors by adjusting the sensor's output as a function of temperature and/or other factors. See, e.g., U.S. Pat. No. 8,683,850, entitled “Real-time dynamic tracking of bias”, the disclosure of which is incorporated here by reference and hereafter referred to as the '850 patent.

While such techniques can be effective, there is still room for improvement in the area of sensor output compensation, generally, and not just in the area of bias compensation for motion sensors which is used purely as an illustrative example above.

### SUMMARY

Motion and audio data associated with an area or a user are sensed and processed jointly to achieve improved results as compared to utilizing only the motion or the audio data by themselves. Synergies between motion and audio are identified and exploited in devices ranging from cell phones to wearables such as smart watches, activity trackers to home entertainment and alarm systems as well as other Internet of Things (IoT) devices and systems.

According to one exemplary embodiment, a device includes at least one sensor for sensing motion of the device and generating at least one motion output, at least one sensor for sensing sounds in a vicinity of the device and generating at least one audio output, and a processor adapted to determine whether a particular condition associated with the device or a user of the device is met using both the at least one motion output and the at least one audio output.

According to another embodiment, a method includes sensing motion of a user and generating at least one motion output, sensing sounds in a vicinity of the user and generating at least one audio output; and determining whether a particular condition associated with the user is met using both the at least one motion output and the at least one audio output.

According to yet another embodiment, a communication device includes at least one microphone, at least one motion sensor, at least one wireless transceiver; and at least one processor; wherein the at least one processor and the at least one wireless transceiver are configured to transmit voice signals received from the at least one microphone over an air interface; wherein the at least one processor is further configured to receive audio data from the at least one microphone and motion data from the at least one motion sensor and uses both the audio data and the motion data to adapt processing of the voice signals for transmission.

### BRIEF DESCRIPTION OF THE DRAWINGS

The accompanying drawings illustrate embodiments, wherein:

FIG. 1 depicts a 3D pointing device and display;

FIG. 2 shows an exploded view of the 3D pointing device of FIG. 1 with motion sensor chips revealed;

FIG. 3 shows a ring-shaped 3D pointing device;

FIG. 4 shows the 3D pointing device being deployed in conjunction with a television user interface and microphones;

FIG. 5 illustrates an audio data processing system according to an embodiment;

FIG. 6 illustrates a motion data processing system according to an embodiment;

FIG. 7 shows vectors associated with motion component decomposition; and

FIG. 8 is a flowchart showing a method according to an embodiment.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

As mentioned above, embodiments presented herein include techniques, systems, software and devices, which can be used in conjunction with, or as part of, systems which gather information using sensors that leverage disparate channels of information to improve sensor output by, for example using data generated from one sensor and one channel of information to improve the quality of data output by another sensor for another, disparate channel of information, e.g., using audio information to improve an output of a motion sensor or vice versa. The following portions of this specification are organized as follows. First an overview of scene analysis, including both audio and video scene analysis, is described. Then specific examples of a motion sensing system and an audio sensing system are provided. Next an example of how to jointly use sensed audio data and motion data to improve a decision is shown in the context of step detection. Finally, various alternatives and generalizations are shown since the embodiments are not limited to audio/motion scene analysis.

Scene analysis is a term used primarily in audio and video processing to refer to identifying the elements of a scene. As mentioned above, a scene can be considered to be an area or volume which surrounds a sensing system's position, and which can be delimited by, for example, the sensing range of one or more of the sensors used by the sensing system, e.g., the sensor having the smallest sensing range. In audio, for example, Albert Bregman is credited with coming up with the idea for “auditory scene analysis”. Auditory scene analysis involves separating out individual sound sources or components within a scene and then integrating those components that belong with each other, e.g., which originate from a same source, while segregating those components that originate from different sources. See, e.g., Bregman in Auditory Scene Analysis, MIT, 1990 and Elyse Sussman, “Integration and Segregation in Auditory Scene Analysis”, Journal of Acoustical Society of America 117 (3), Pt. 1, March 2005, pp. 1285-1298, the disclosures of which are incorporated here by reference and referred to jointly below as “the auditory scene analysis articles”.

To better understand auditory scene analysis, consider the following example. Imagine sitting outside at a café in a plaza. There are birds making different sounds in the plaza, cars going by, people chatting at tables nearby, the sound of the moving river across the bank and so on. Those are all sounds that originate from different sources and are perceived together, e.g., by a person's ears or a microphone disposed in the plaza. The process of auditory scene analysis separates those sources and their corresponding sounds out from the composite scene for individual analysis and enables them to be operated upon separately. For example, a sensing system which performs auditory scene analysis on this scene might choose to mute all of the sounds other than the bird noises, or to try to focus on the people's conversations by amplifying the auditory data associated with only those sources. Filtering, amplification, noise reduction, etc., are just a few of the examples of operations which can be performed on audio data after auditory scene analysis has been performed.

Visual scene analysis is similar to auditory scene analysis but applies to perceived images rather than audio. Imagine the same café scene as described above but this time consider how the video image of that scene is perceived by the eyes of an observer or a camera disposed in the plaza. All (or at least most) of those objects that made sounds plus many that didn't (e.g., a chair, a table, a building) are merged into one composite image that is recorded by the image sensor(s). The process of visual scene analysis separates those individual objects out for separate analysis and operation.

Scene analysis, whether it be auditory or visual, can be quite useful. In the case of auditory scene analysis, this general technique can, in principle, allow for synthesizing an audio signal with only the component of interest, say the voice of the person across the table from you, while removing all the interfering noises of all the other people around, the construction noise down the street and so on. The result is a cleaner audio signal that could then better be transferred over a phone connection or perhaps used for speech recognition and the like. Performing video scene analysis offers its own analogous benefits in the visual domain.

While a conventional auditory scene analysis only concerns itself with audio input from one type of data channel (i.e., an audio channel type, albeit possibly from several different physical channels, i.e., different microphones) and a conventional visual scene analysis only concerns itself with image input from one type of data channel (i.e., an image channel type, albeit possibly from several different physical cameras), embodiments described herein instead perform scene analysis (and other functions) by operating on multiple dimensions/different types of data channels to provide what is referred to herein as Composite Scene Analysis and Fusion (CSAF). CSAF synthesizes a “Composite Scene” containing all the information about the scene from all the available sensors (including data and metadata from the cloud as appropriate). For the café example discussed earlier, this composite scene would ideally include information on the location and audio characteristics from all of the audio sources detectable by the microphones along with information on the acoustic properties like absorption and reflectivity from all the various objects and surfaces in the 3D space around the applicable sensors. The composite scene would also ideally include all the position, orientation and motion information on all the relevant physical objects in the 3D space around the applicable sensors such as the device itself, the person holding the device (if that's the case) and so on. If visual sensors are available, the composite scene would ideally identify all visual elements in the scene such as tables, chairs, people, cars, the river and so on. If there are other information inputs available, the composite scene would include them too. The “Analysis and Fusion” part of CSAF refers to the inferences and linkages formed between the layers of the Composite Scene as well as the work to segregate the original input information so that portions could be attributed to each element separately.

For example, a CSAF system according to an embodiment could possess both auditory and visual sensors to operate on both audio and image data channels in a manner which can improve the overall functionality of each. More specifically, such embodiments can provide (but are not limited to) two different sorts of benefits by virtue of operating on multiple types of data channels. The first benefit is that embodiments can improve the readings from an individual sensor or even enhance a particular type of scene analysis, e.g., for a combined audio/image sensing system improving the output of the audio sensor, or the auditory scene analysis, using the output of the visual sensor. The second benefit is that embodiments can better infer higher level knowledge of what is occurring in the scene, e.g., by combining and merging the information gleaned from the individual observations. As an example of the first benefit, let's consider a scenario where a female user with high heels is walking across a hard wood floor while talking on the phone. Normally, the reverberant heel strikes would interfere with the speech and be tough for an audio-only system to deal with since they are intermittent and from multiple locations (once echo is included). However, once motion scene analysis identifies the heel strikes in time, the audio system can better align and separate out the heel strike echoes from the acoustics and isolate on the desired speech. This is one example of motion processing improving the acoustic scene analysis.

As an example of the second benefit, consider a CSAF system which is connected to a higher level system that would like to understand whether the user is working at the office, just walking or playing tennis. Acoustics alone might help since the background sounds of the office differ from those of a tennis court but they aren't definitive. Motion analysis helps since tennis movements involve both arms and legs in a different way than just walking But combining determinations from the Acoustic Scene Analysis and the Motion Scene Analysis together yields a better quality determination overall than either would alone.

The foregoing provides a high level description of CSAF embodiments using audio, video and motion as general non-specific examples of synergistically performing scene analysis using disparate data channels, primarily since audio and video domains have themselves been investigated in depth for many decades, and are frequently used together (albeit not in scene analysis) as input and output data. However the embodiments described herein contemplate CSAF systems which operate on even more disparate types of data channels, some of which have only much more recently come into use in commercial products. For example, and as mentioned earlier, one such data channel is motion and one such CSAF embodiment operates on one or more motion data channels as well as one or more audio data channels.

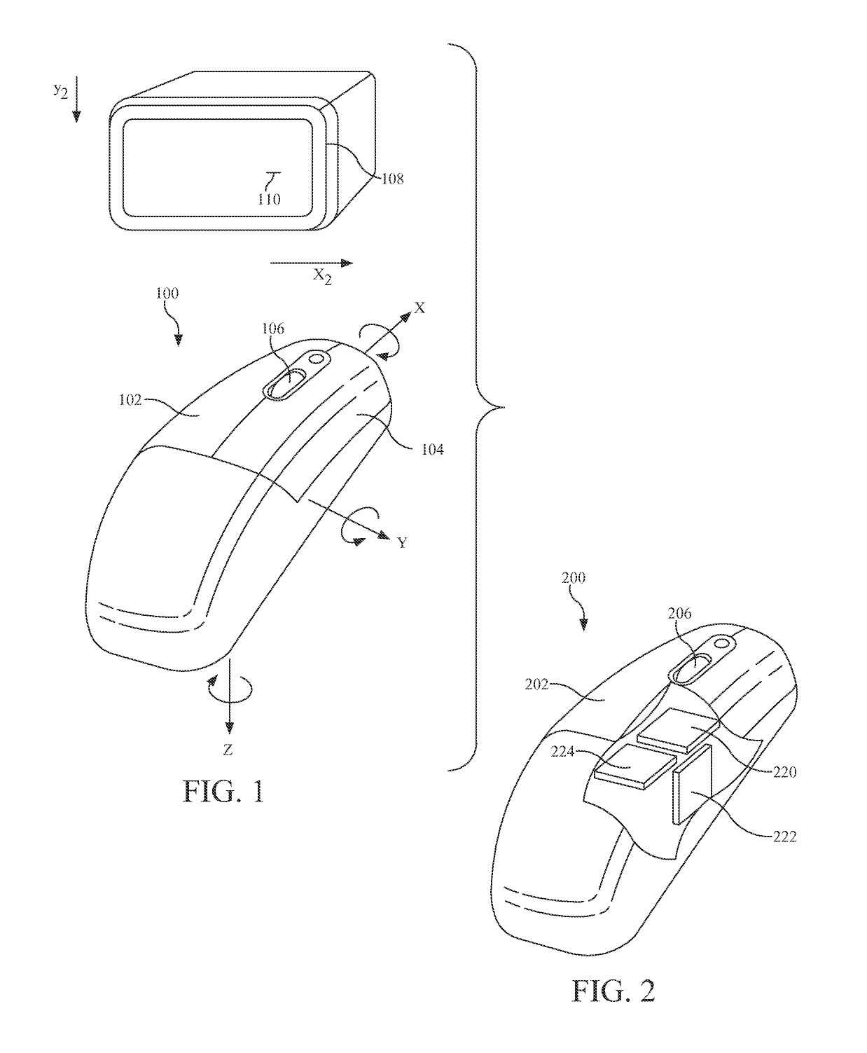

As a precursor to discussing motion scene analysis and then discussing CSAF embodiments involving both motion and audio channels, a brief example of a motion sensing device/system is provided for context. Remote devices which operate as 3D pointers are examples of motion sensing devices which enable the translation of movement, e.g., gestures, into commands to a user interface. An exemplary 3D pointing device 100 is depicted in FIG. 1. Therein, user movement of the 3D pointing can be defined, for example, in terms of a combination of x-axis attitude (roll), y-axis elevation (pitch) and/or z-axis heading (yaw) motion of the 3D pointing device 100. In the example of FIG. 1, the 3D pointing device 100 includes two buttons 102 and 104 as well as a scroll wheel 106, although other physical configurations are possible. In this example, 3D pointing devices 100 can be held by a user in front of a display 108 and motion of the 3D pointing device 100 will be sensed by sensors inside the device 100 (described below with respect to FIG. 2) and translated by the 3D pointing device 100 into output which is usable to interact with the information displayed on display 108, e.g., to move the cursor 110 on the display 108. For example, rotation of the 3D pointing device 100 about the y-axis can be sensed by the 3D pointing device 100 and translated into an output usable by the system to move cursor 110 along the y₂ axis of the display 108. Likewise, rotation of the 3D pointing device 108 about the z-axis can be sensed by the 3D pointing device 100 and translated into an output usable by the system to move cursor 110 along the x₂ axis of the display 108.

Numerous different types of sensors can be employed within device 100 to sense its motion, e.g., gyroscopes, angular rotation sensors, accelerometers, magnetometers, etc. It will be appreciated by those skilled in the art that one or more of each or some of these sensors can be employed within device 100. According to one purely illustrative example, two rotational sensors 220 and 222 and one accelerometer 224 can be employed as sensors in 3D pointing device 100 as shown in FIG. 2. Although this example employs inertial sensors it will be appreciated that other motion sensing devices and systems are not so limited and examples of other types of sensors are mentioned above. The rotational sensors 220, 222 can be 1-D, 2-D or 3-D sensors. The accelerometer 224 can, for example, be a 3-axis linear accelerometer, although a 2-axis linear accelerometer could be used by assuming that the device is measuring gravity and mathematically computing the remaining 3^{rd} value. Additionally, the accelerometer(s) and rotational sensor(s) could be packaged together into a single sensor package. Other variations of sensors and sensor packages may also be used in conjunction with these examples.

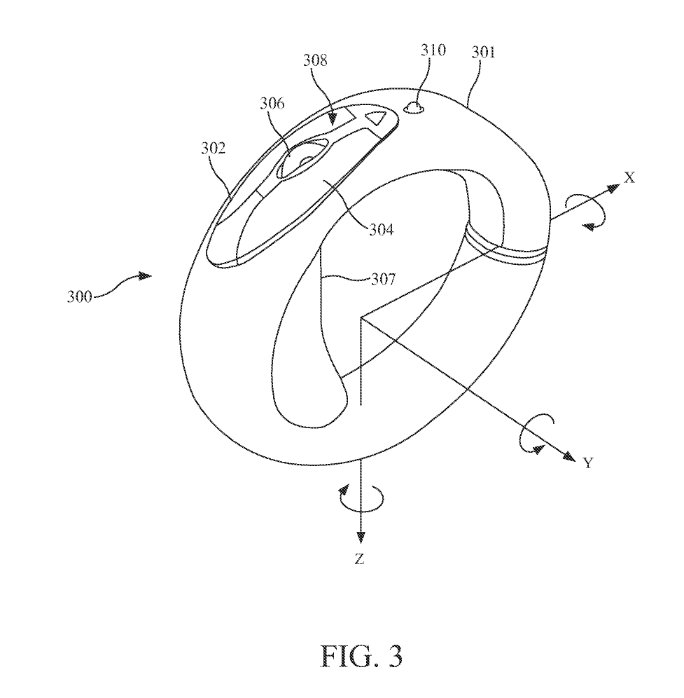

A handheld motion sensing device is not limited to the industrial design illustrated in FIGS. 1 and 2, but can instead be deployed in any industrial form factor, another example of which is illustrated as FIG. 3. In the example of FIG. 3, the 3D pointing device 300 includes a ring-shaped housing 301, two buttons 302 and 304 as well as a scroll wheel 306 and grip 307, although other exemplary embodiments may include other physical configurations. The region 308 which includes the two buttons 302 and 304 and scroll wheel 306 is referred to herein as the “control area” 308, which is disposed on an outer portion of the ring-shaped housing 301. More details regarding this exemplary handheld motions sensing device can be found in U.S. patent application Ser. No. 11/480,662, entitled “3D Pointing Devices”, filed on Jul. 3, 2006, the disclosure of which is incorporated here by reference. In accordance with further embodiments described below, the handheld motion sensing device may also include one or more audio sensing devices, e.g., microphone 310.

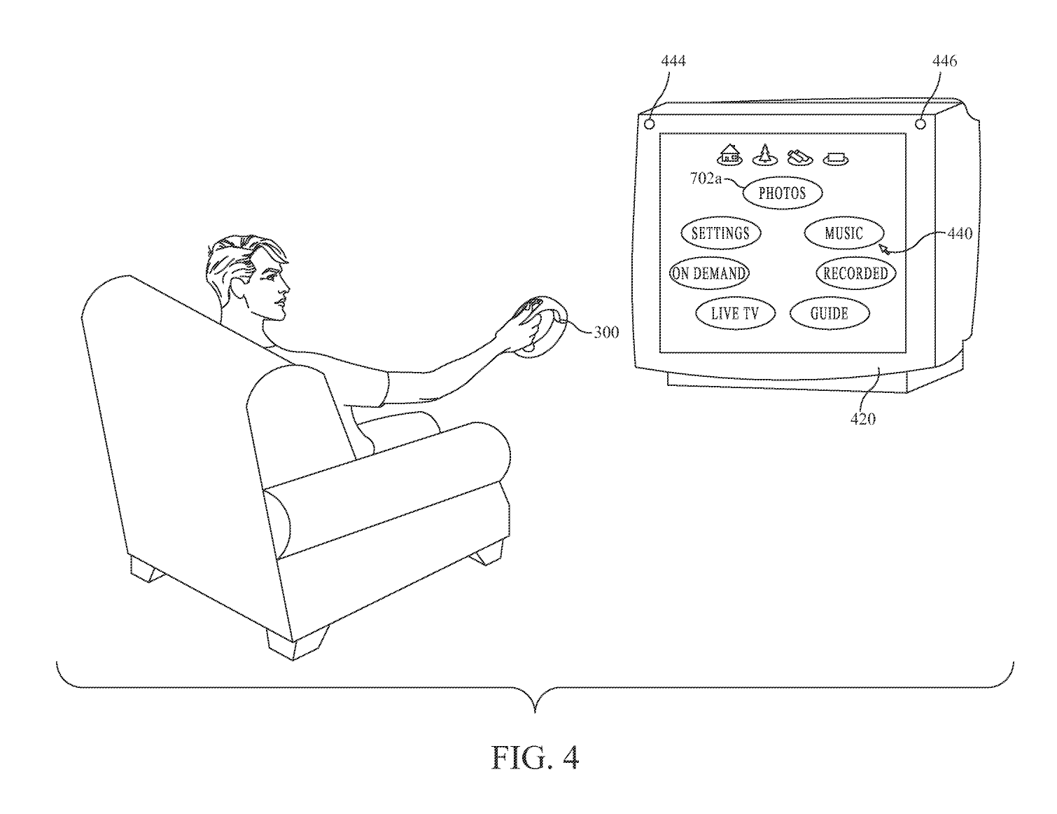

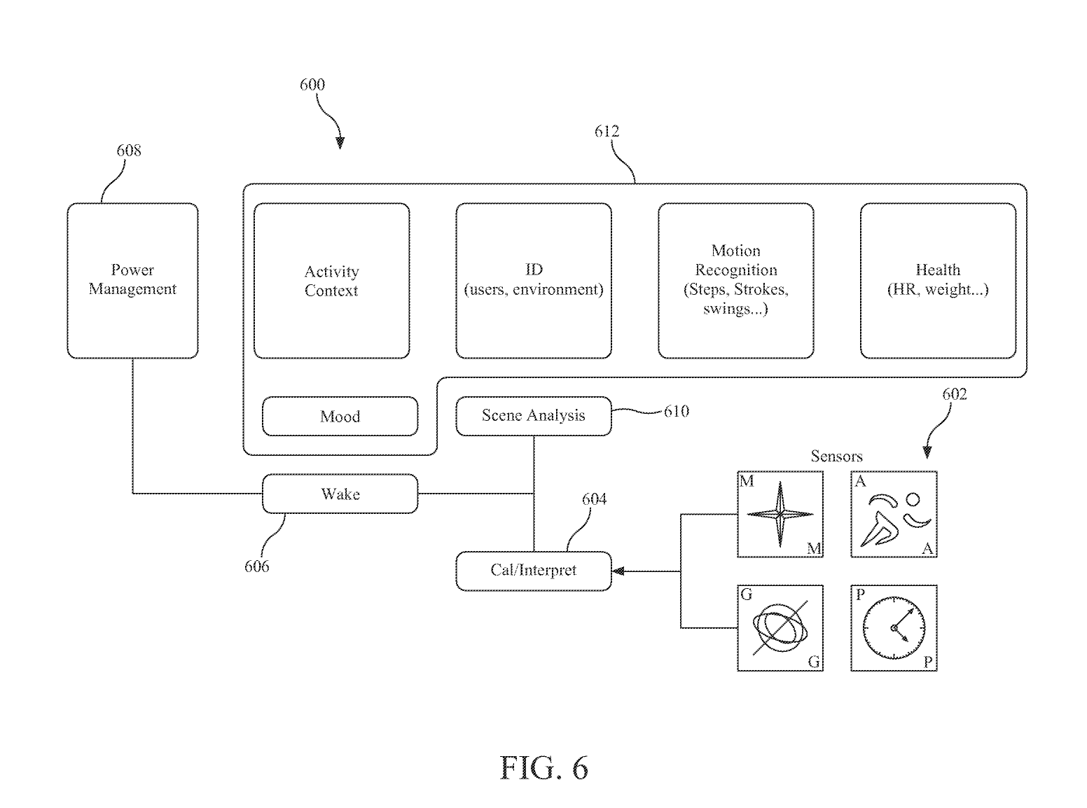

Such motion sensing devices 100, 300 have numerous applications including, for example, usage in the so-called “10 foot” interface between a sofa and a television in the typical living room as shown in FIG. 6. Therein, as the 3D pointing device 300 moves between different positions, that movement is detected by one or more sensors within 3D pointing device 400 and transmitted to the television 420 (or associated system component, e.g., a set-top box (not shown)). Movement of the 3D pointing device 400 can, for example, be translated into movement of a cursor 440 displayed on the television 420 and which is used to interact with a user interface. Details of an exemplary user interface with which the user can interact via 3D pointing device 300 can be found, for example, in the above-incorporated U.S. patent application Ser. No. 10/768,432 as well as U.S. patent application Ser. No. 11/437,215, entitled “Global Navigation Objects in User Interfaces”, filed on May 19, 2006, the disclosure of which is incorporated here by reference. Additionally, in support of embodiments described below wherein audio sensing is performed in conjunction with motion sensing, the television 420 can also include one or more microphones (two of which 444 and 446 are illustrated in FIG. 4).

It shall be appreciated that the examples provided above with respect to FIGS. 1-4 provide, for context, examples of motions sensing devices and systems, as well as systems which can perform both motion and audio sensing. However the CSAF embodiments described below are equally applicable to any systems which employ disparate sensor combinations. Examples of other devices which have multiple different types of sensors include, but are not limited to, cell phones, tablet devices, activity monitoring devices (wearable or handheld), sensor-enabled clothing, gaming systems and virtual reality gear as well as IoT systems including Smart Homes and Smart Factories. Also note that it is not at all required that the sensors be mounted in a single device or in the same physical location. Indeed, as seen in FIG. 4 where the motion sensors are disposed in the 3D pointing device 400 and the microphones 444, 446 are disposed in the television 420, it is fully contemplated that the sensors associated with a given CSAF system may be located in different devices/places.

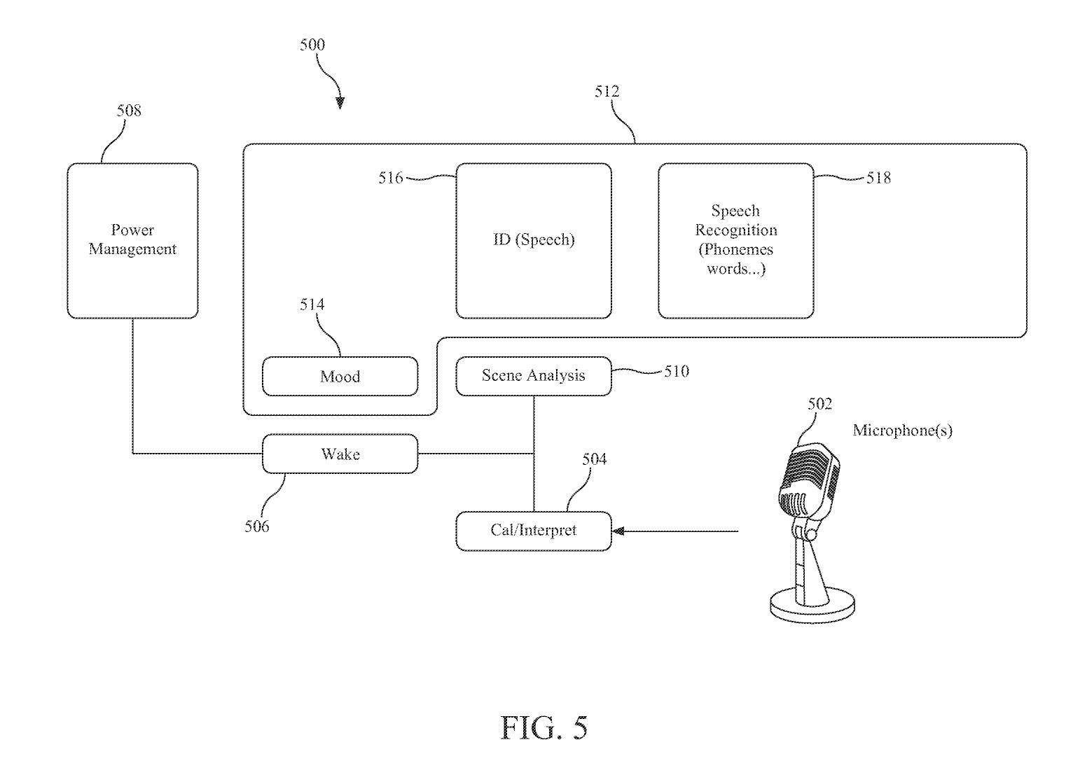

The data captured by the sensors which are provided in such systems can then be processed to, for example, audio scene analysis and/or motion scene analysis. A high level example of an audio processing function/system 500 is provided as FIG. 5. In the figure, sounds are sensed using one or more microphones 502 shown at the bottom right. Those signals are then refined in a calibration and interpretation block 504. The resulting (clean) audio signal then goes to several blocks. First, the clean signal goes to a wake block 506 which decides whether or not the audio data contained in the clean audio signal indicates that a keyword or keyphrase has been uttered by someone in the scene. If so, then power management block 508 is informed so that one or more other devices associated with the system the device can be wakened from a standby power state. For example, in the context of the system of FIG. 4, either (or both) of the 3D pointing device 300 or the television 420 could be awakened if the keyword or keyphrase is detected.

The other processing block that the clean audio signal is forwarded to is the scene analysis block 510. Here, the clean audio signal is resolved into constituent parts as described previously or in the manner described in the above-incorporated by reference auditory scene analysis articles. The processing performed by the scene analysis block 510 can generate data which then drives the various functions in the box 512, which are merely illustrative of various functions which can be used to operate on the audio components depending upon the particular application of interest. In this example, such functions 512 include a block 514 to determine the mood of the speaker (e.g., happy, sad), a block 516 to identify the speaker based on the characteristics of the speech provided by the scene analysis block 510, and a third block 518 is a speech recognition engine to detect the words, and possibly phonemes, in the detected speech.

A similar processing function system 600 can be provided to process sensed motion data, and to provide motion scene analysis according to an embodiment, an example of which is provided in FIG. 6. In the figure, motion is sensed primarily from one or more sensors, examples of which are pictorially depicted at the bottom right of the diagram and labelled as a group 602. Therein, the block with an “M” in the upper left and lower right corners represents a magnetometer. The block with an “A” in the upper left and lower right corners represents an accelerometer. The block with a “G” in the upper left and lower right corners represents a gyroscope. The block with a “P” in the upper left and lower right corners represents a pressure or barometric sensor. Again, these sensors are just illustrative and an actual embodiment may contain more than one of these sensors, multiple combinations of these sensors, or even totally different sensors altogether such as GPS sensors, ultrasound sensors, rotation sensors, infrared sensors, depth cameras, etc. The outputs of the sensor or sensors are then sent to a calibration and interpretation block 604 which adjusts the motion data signals to deal with things like bias and scale, e.g., as described in the above-incorporated by reference '850 patent. The resulting calibrated/interpreted signals are then sent to two blocks. The first is a wake block 606 which determines whether or not any significant motion is occurring. If there is significant motion occurring, a signal is sent by the wake block 606 to the power management block 608 to move a device in the system out of standby operation and into normal operation. For example, in the context of the system of FIG. 4, either (or both) of the 3D pointing device 300 or the television 420 could be awakened if the significant motion is detected.

The second block to which the calibrated motion signals are sent is the scene analysis block 610. In block 610 the individual elements of the motion are determined Those motion elements then support a number of different potential applications as shown in block 612. Note that block 612 merely provides an exemplary rather than exhaustive list of applications which can be driven based on motion elements received from the motion scene analysis block 610. One is an application processing block which determines the mood of the device wearer (e.g., happy, sad) based on one or more motion elements. Another block determines the activity the device wearer is engaged in (e.g., walking, swimming, weight lifting). A third block identifies either the device wearer or the environment the device is in. A fourth block recognizes and/or measures the motion elements (e.g., steps, strokes, swings). The final example block measures some of the biomarkers and/or biometrics of a person (e.g., heartrate, weight).

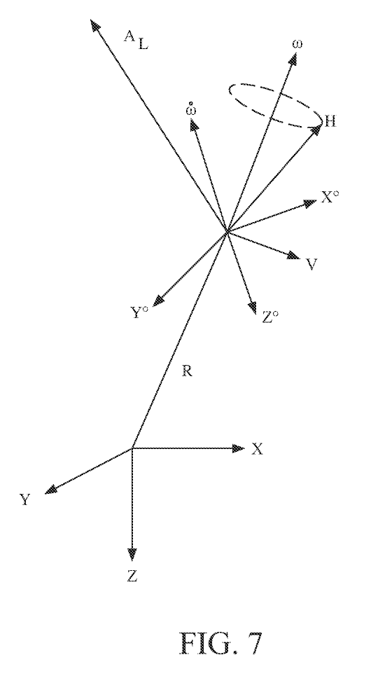

The motion scene analysis block 610, for example, decomposes the calibrated motion signal which it receives into motion measurements for all the rigid body elements in the scene. Each of those individual rigid body element motion measurements fit, for example, a simplified ideal motion model which gives the total acceleration of a ridged body relative to a selected origin and center of rotation is described below and illustrated in FIG. 7. For example, the simplified ideal motion model can be expressed by the following equation:

Aₙ=A_{L}+ [symbol] ×Hₙ+ω×(ω×Hₙ)+Eₙ

where:

Aₙ=Acceleration at the point

A_{L}=Linear acceleration

[symbol] =Angular acceleration

ω=Angular Velocity

Hₙ=Vector from center

Eₙ=Error

Note that the center of rotation and origin may be selected arbitrarily.

When breaking down a set of motion readings from, say, a mobile phone held in someone's hand into a Motion Scene one ideally includes elements such as in this following list of Motion Scene Analysis Basics. A particular embodiment may choose to only do some of these or might choose to do more of them depending on the constraints and goals of the embodiment in question. For the purpose of the list below and this example, each body part (such as forearm or thigh) is considered a separate rigid body as is the phone itself. Again, the particular way a Motion Scene is broken down depends on the goals and constraints of the embodiment in question (analogous to the Acoustic Scene and Visual Scene).

Tremor
Motion sensors can sense both intended and unintended motions. For example, when a user holds a device in his or her hand, motion sensor(s) within the device can track that user's intentional hand motions, but will also pick up unintended motions like tremor. For a discussion of tremor sensing using handheld devices with internal motion sensor(s), the interested reader is directed to U.S. Pat. No. 8,994,657, entitled “Methods and Devices for Identifying Users based on Hand Tremor”, the disclosure of which is incorporated here by reference. Each joint has its own tremor pattern. In a Motion Scene Analysis where tremor is an important component to separate out, ideally tremor component of each limb or body part would be isolated. The resulting breakdown should, for example, indicate that the phone itself (unless the vibrator is buzzing) has no tremor while the hand holding it, along with the forearm and upper arm, do have tremor. Isolating the tremor allows one to distinguish intended from unintended motion, gauge stress, infer muscle strain, distinguish individuals and states etc.

Inverse Kinematics
The movement of each body member is not totally independent because they are joined together. Through processes like inverse kinematics, the movement of the palm can be modelled independently from the movement of the forearm and so on. Since body structure is relatively stable over short periods of time, the CSAF system can learn body structure from motion histories and then use that body structure to improve motion segregation in this step.
The presence of multiple sensors across the body helps to improve the accuracy of this step.

Contextually Irrelevant Motion Separation
Sometimes motion components exist that are contextually irrelevant and so some embodiments want to isolate them as part of the Motion Scene Analysis. For example, when a user presses a button on the device, the user can involuntarily move the device in the process. That extra movement is often not desired (see, e.g., U.S. Pat. No. 8,704,766, entitled “Apparatuses and Methods to Suppress Unintended Motion of a Pointing Device”, the disclosure of which is incorporated here by reference). Therefore isolating it from the other motion signals is worthwhile.
Similarly, when estimating step length, sometimes it is the motion perpendicular to the walking surface that is relevant and so separating this particular motion component out from all the other parts of the motion signals is worthwhile.
Another example is the inadvertent hand motion that is useful when counting steps.
Yet another example is leg motion when we are checking arm motion.
A different sort of example is when the car or bicycle hits a bump in road; the resulting vibratory motion is best isolated as a unit for analysis.

Motion from Other Source
Often the person is moving but with the assistance of another device. If so, isolating that device's motion and distinguishing it from the human's motion per se is often useful. Examples include tire rotation and car movement/rotation for cars, buses and bicycles or car oscillation and movement for trains or sway and movement for boats or ground motion for earthquakes, escalators or moving walkways.

Other Sources Including Motion Mimicry
Magnetic field disturbances can be either signal (e.g., location fingerprinting) or noise (soft iron disturbances shifting apparent North) depending on the application. Either way, isolating information derived from them can be useful. Car bumps can yield nonlinear changes in motion sensors and it is therefore useful to identify when they occur.
Other motions are good to isolate and remove in order to make true motion inference more accurate. One example is isolating device bumps such as the mobile phone jostling in the user's pocket.

The motion scene analysis system described above with respect to FIG. 6 can be used by itself according to some embodiments to generate a number of interesting and useful results. For example, one area in which such a motion scene analysis system can be used is in the context of orientation. The orientation of an element in a scene is a typically a desired, and often necessary, byproduct of motion scene analysis. Orientation can be described in a variety of levels. For example, a first level is an orientation of the device itself. In the context of FIG. 4, this would, for example provide a determination of the orientation of the device 300 relative to some reference, e.g., the gravity vector. A second level is an orientation of the device relative to the body, e.g., the orientation of device 300 relative to the user depicted in FIG. 4, while a third level is the relative orientation of the device to all the relevant limbs of the user and, if present, other body-mounted devices.

The value of motion scene analysis (MSA) stretches across many categories since a more complete and correct MSA yields value across the application set, for example:

Pointing—only relevant motion is considered
Natural motion—only body motion is considered
Pedestrian navigation—if MSA was perfect, there would be no need for continual GPS reads
Contextual Sensor Fusion—better MSA is a major input to contextual decisions
Fingerprint mapping—better MSA allows for better mapping as well.

While some embodiments and applications may benefit from using motion scene analysis by itself, other embodiments may benefit by further augmenting MSA using one or more other, disparate data channels. A specific example will now be provided where audio scene analysis and motion scene analysis are both performed to augment a determination regarding whether a person in the scene performed a “step”. For example, activity trackers today are commonly designed to count the number of steps that a person takes, e.g., on a daily basis, as part of a regimen for recording a user's physical activity level. Thus such devices will benefit from more accurate decision making regarding whether or not a particular motion by a user's legs should be counted as a step, or not.

First, consider the audio processing of a step or heel strike. Via the acoustic scene analysis described above, the sound component of a heel striking the floor can be isolated. By analyzing and comparing the sound patterns across, for example, spatially separated microphones (if available), the approximate direction of the heel strike relative to the sensing device(s) can optionally be determined. Furthermore, the precise timing and even sound intensity of the step can be determined. Sound analysis can thus determine when the floor type changes from, say, tile to carpet and can also signal when the striking foot pivots as well as hits the floor (indicating a turn). All of this information can be used separately or jointly to determine within some probability whether, at a given time t, a person in the scene performed a “step” based solely on audio data collected by the microphone(s).

Next consider the motion processing of a step or heel strike. Via the motion scene analysis described above, some parameters related to a step can be determined which are analogous to those determined using audio scene analysis. First, by using gravity, the orientation of the device (e.g., handheld or wearable) can be determined (apart from a yaw rotation). Yaw rotation can, for example, be determined via tracking magnetic fields (e.g., magnetic North direction) and/or by determining the traveling direction of the person and mapping the traveling direction back to the phone orientation. The traveling direction of a person can be analyzed, for example, by isolating and tracking the horizontal acceleration and deceleration perpendicular to gravity that the user induces with each step push off and heel strike.

Each scene analysis can help the other. First, the precise vibration detection of a heel strike available from the motion sensor(s) can help with full isolation of the acoustic signature of that heel strike. This can help improve accuracy of a heel strike detection by the audio scene analysis when the acoustic signal gets weaker, for example, when the user walks on carpet instead of tile. Then, too, the acoustic signal can help improve the motion scene analysis as well. For example, when the user steps more lightly on the floor, the sound may be detected more easily than the vibration and acceleration forces generated by the heel strike, and can be used to improve the determination made by the motion scene analysis.

The foregoing provides some high level examples of how disparate channels of information can be used jointly to provide better scene analysis and/or better decision making associated with information derived from a scene according to various embodiments. A more detailed, and yet purely illustrative, example will now be provided. For example, one way to express the joint usage of disparate channels of information in a CSAF embodiment mathematically for the step/heel strike example given above is with the following equations: Let heel-strikeₜ^{a} represent the probability that a heel strike occurred at time t based on audio analysis. Let σₘ² represent the variance of that acoustical determination of heel strikes. Let heel-strikeₜ^{m} represent the probability that a heel strike occurred at time t based on motion analysis. Let σₘ² represent the variance of that motion determination of heel strikes. An example of a CSAF embodiment (i.e., sensor fusion result) can then be expressed as

$$heel \text{-} {strike}_{t}^{fused} = ( \frac{\frac{1}{{σ}_{a}^{2}}}{\frac{1}{{σ}_{a}^{2}} + \frac{1}{{σ}_{m}^{2}}} ) heel \text{-} {strike}_{t}^{a} + ( \frac{\frac{1}{{σ}_{m}^{2}}}{\frac{1}{{σ}_{a}^{2}} + \frac{1}{{σ}_{m}^{2}}} ) heel \text{-} {strike}_{t}^{m}$$

Those skilled in the art will appreciate that blending the audio information and the motion information to generate a step or heel strike conclusion can be performed in numerous other ways (e.g., Kalman filtering, Maximum Likelihood, etc.) and that the foregoing is merely one example.

The example of FIGS. 1-4 involve motion sensing in a 3D pointer, discussed above is motion sensing in an activity tracker, yet numerous other opportunities for CSAF embodiments can be found. Consider cell phones which also typically include microphone(s) and one or more motion sensors. Cell phones can also benefit from CSAF in the context of, for example, acoustic path patterns and room change, acoustic path patterns and directional inference, and phone orientation relative to mouth and ear. Regarding this latter feature, consider that optimal acoustic processing depends on how the phone is positioned relative to the user's mouth and ear. Determining that solely acoustically can be challenging. However, MSA can help by identifying the orientation of the phone in 3D space by using, for example, the magnetic field and/or gravity as references. Then combining the determined orientation with a proximity sensor can alert the audio processing system in the phone as to the likely position of the device relative to the user's mouth and ear. For example, if the proximity detector indicates that the phone is close to the user's skin, the orientation angle of the phone can determine the likely distance between the phone's microphone and the user's mouth. It could also differentiate that case from one where the phone is held out in front of the user—a position one sometimes sees with mobile video-conferencing, for example. In that case, both the orientation angle of the phone and the proximity sensor readings are different than before. In general then, the position of the device relative to a user's mouth and/or ear can then be used, for example, to adjust the processing of the voice signals being received by the phone's microphone or output via the phone's speaker. For example, the amplification and/or filtering of the speech signal received via the microphone can be varied as a function of the user's mouth's proximity to the microphone as part of the processing of those signals prior to transmission over an air interface by the phone's wireless transceiver.

Similarly, embodiments can be used to adapt for a phone's location in car or vehicle (e.g., cup, seat). Different locations of the phone in a car can influence the optimal acoustical processing parameters for that phone (e.g., frequency shaping, reverberation control, volume). Since the vibration patterns and orientation angles of a phone in the cupholder or ashtray differ from being on a seat, the MSA can provide this information to the audio processing system to enable the audio processing system to adapt its audio processing based on the phone's location within the car.

Context decisions can also be improved with MSA and ASA together according to various other embodiments, e.g. using vehicle sounds and movement together rather than just one or the other to determine if an authorized user/operator is present in a vehicle. In-vehicle identification can be difficult to infer with just motion sensors. Typically some variation of motion pattern recognition as people get in and out of cars, vibration detection, magnetic field patterns and horizontal plane acceleration are used to detect whether the phone is in a vehicle or not. However audio processing can aid in this detection quite a bit—at least for the typical car. The sound of the car starting up, the car system's message sounds, road and traffic noise and the like can all be detected and augment the overall classification decision.

CSAF provides for other improvements to current audio and motion features including, but not limited to, improved audio processing through better detection of phone position, improved motion detection through inclusion of sound data, and background context used to adjust vibrate/notification levels. Additionally, CSAF provides for new health and fitness functionality, e.g., improved sleep monitoring and apnea “diagnosis” through combination of actigraphy, research work and breathing pattern analysis. In this context, it will be appreciated that actigraphy refers to inferring sleep state and/or level by analyzing motion signals from an accelerometer. Actigraphy can achieve moderate accuracy but is very far from matching the gold standard in the industry—i.e., PSG or Polysomnography. The problem with PSG is that it is cumbersome with lots of wire probes attached to the body and requires analysis by a trained clinician to interpret the output. An easier to use home monitoring system which gets closer to the PSG answer than actigraphy is desired.

Audio processing is one way to improve accuracy of actigraphy. Via a microphone, the unit can hear the breathing patterns of the patient. By detecting the volume and regularity of those patterns—including snoring, if present—additional information re the patient's sleep state is obtained. One illustrative embodiment follows and is based on the fact that conventional snoring is unlikely in REM sleep while sleep apnea snoring is most likely in REM sleep. Sleep apnea snoring involves intermittent “noisy recovery breaths”. REM sleep is also the state where the skeletal body muscles are the most relaxed. Therefore, we can have two detectors, REMₜ^{b} and REMₜ^{m} which represent the probability that the user is in REM sleep based on breathing and motion determinations respectively. The breath detector could, for example, be implementing by comparing the deviations in timing and volume between the current breath cycle and the immediate average. The motion detector would be one based on actigraphy and be looking for a very small amount of motion. Let σ_{b}² represent the variance of that acoustic breathing-based determination of whether or not the user is in REM sleep. Let σₘ² represent the variance of that motion-based determination of whether or not the user is in REM sleep. Then one CSAF embodiment of a sensor fusion result could then be expressed as follows:

$${REM}_{t}^{fused} = ( \frac{\frac{1}{{σ}_{b}^{2}}}{\frac{1}{{σ}_{b}^{2}} + \frac{1}{{σ}_{m}^{2}}} ) {REM}_{t}^{b} + ( \frac{\frac{1}{{σ}_{m}^{2}}}{\frac{1}{{σ}_{b}^{2}} + \frac{1}{{σ}_{m}^{2}}} ) {REM}_{t}^{m}$$

Those skilled in the art will appreciate that this blending could also performed in numerous other ways (e.g., Kalman filtering, Maximum Likelihood, etc.) and that the foregoing is merely one example. That in turn could be further augmented with information like heart rate and heart rate variability and other biometrics. Similar combinations of audio information with existing biometric monitoring could include an exercise monitor enhanced with breath pattern analysis, health monitoring via breathing, motion, temperature and even internal body sounds (e.g., a contact microphone disposed in a wearable for heartbeat), stride and breathing analysis, sound-based detection of under/above water state (useful for swimming for example) and fall detection for aging in place applications.

Regarding the latter topic of fall detection, motion processing can be used to detect falls by detecting the motion pattern anomalies when the user falls as compared to walking or sitting down normally. However, there are a number of user behaviors which make it difficult to properly detect falls. For example, a slow fall is difficult to distinguish from a normal sitting down movement. Also, lying down purposefully on a bed can appear similar to falling prone on the floor at a moderate speed.

Audio processing can aid in distinguishing those cases. The sound of someone hitting the floor is different than the sound of someone hitting the bed. The “oomph” or involuntary groan of a person who falls can be recognized and lined up with the motion that preceded it to help distinguish a fall from something normal. The sound of a person after a potential fall event is different as well. In the case of lying down, one might hear the sound of a TV or breathing. In the case of falling down, one might here an occasional moan or a strained breathing sound.

Other new functionality is also possible using other CSAF embodiments, including, for example, Body Area GPS for multi-device case with audio ToA (Time of Arrival), Deep Belief Networks, with sound and motion, to improve Latency Adjustment feature and Biometric Fingerprint assessment for user authentication and Context State decisions and Extended context detection through band-based analysis.

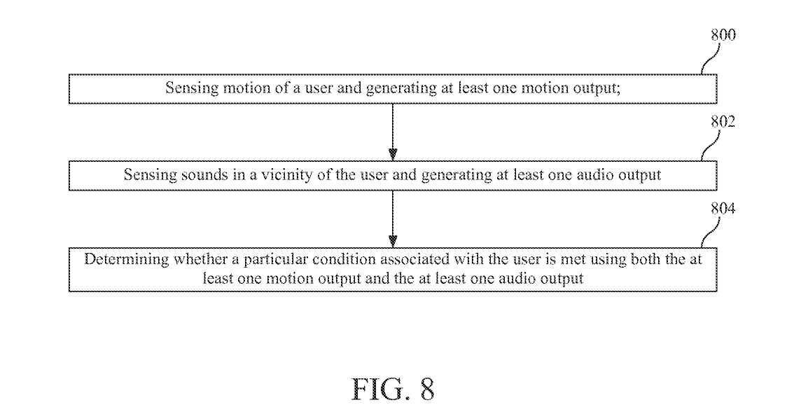

CSAF thus involves systems, devices, software and methods, among other things. One example of a method embodiment is illustrated by the flowchart of FIG. 8. Therein, at step 800 motion of a user is sensed and at least one motion output is generated based on the sensed motion. At the same time or approximately the same time, sounds in a vicinity of the user are also sensed and at least one audio output is generated based on those sounds at step 802. Then, it is determined whether a particular condition associated with the user is met, or whether a particular event associated with the user has occurred, using both the at least one motion output and the at least one audio output, as indicated by step 804.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within the device, e.g., a 3D pointing device, cell phone or other device, which contains the sensors or the software may run on a processor or computer housed within another device, e.g., a system controller, a game console, a personal computer, etc., which is in communication with the device containing the sensors. In such a case, data may be transferred via wireline or wirelessly between the device containing the sensors and the device containing the processor which runs the software which performs the CSAF methodology as described above. According to other exemplary embodiments, some of the processing described above with respect to bias estimation may be performed in the device containing the sensors, while the remainder of the processing is performed in a second device after receipt of the partially processed data from the device containing the sensors.

Although some of the foregoing exemplary embodiments relate to sensing packages including one or more rotational sensors and an accelerometer, CSAF techniques according to these exemplary embodiments are not limited to only these types of sensors. Instead CSAF techniques as described herein can be applied to devices which include, for example, only accelerometer(s), optical and inertial sensors (e.g., a rotational sensor, a gyroscope or an accelerometer), a magnetometer and an inertial sensor (e.g., a rotational sensor, a gyroscope or an accelerometer), a magnetometer and an optical sensor, or other sensor combinations. Additionally, although exemplary embodiments described herein relate to CSAF techniques in the context of 3D pointing devices, cell phones, activity trackers and related applications, such techniques are not so limited and may be employed in methods and devices associated with other applications, e.g., medical applications, gaming, cameras, military applications, etc.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments describe, among other things, the use of inertial sensors to detect movement of a device, other types of sensors (e.g., ultrasound, magnetic or optical) can be used instead of, or in addition to, inertial sensors in conjunction with the afore-described signal processing. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A device comprising:
at least one sensor for sensing motion of said device and generating at least one motion output;
at least one sensor for sensing sounds in a vicinity of the device and generating at least one audio output;
a processor adapted to determine whether a particular condition associated with the device or a user of the device is met using both the at least one motion output and the at least one audio output.

2. The device of claim 1, wherein the processor is further adapted to decompose an audio scene, based on the at least one audio output, into component audio elements which are each associated with a different audio source, and further wherein the processor is adapted to adjust at least one of the component audio elements using the at least one motion output.

3. The device of claim 1, wherein the processor is further adapted to decompose a motion scene, based on the at least one motion output, into component motion elements, and further wherein the processor is adapted to adjust at least one of the component motion elements using the at least one audio output.

4. The device of claim 1, wherein the particular condition associated with the device is whether a user holding or wearing the device has taken a step.

5. The device of claim 4, wherein the processor is further adapted to determine a value associated with a probability that the step has occurred based on both the at least one motion output and the at least one audio output.

6. The device of claim 5, wherein the processor determines a value associated with the probability that the step has occurred by calculating:
$$( \frac{\frac{1}{{σ}_{a}^{2}}}{\frac{1}{{σ}_{a}^{2}} + \frac{1}{{σ}_{m}^{2}}} ) heel \text{-} {strike}_{t}^{a} + ( \frac{\frac{1}{{σ}_{m}^{2}}}{\frac{1}{{σ}_{a}^{2}} + \frac{1}{{σ}_{m}^{2}}} ) heel \text{-} {strike}_{t}^{m}$$
where:
heel-strikeₜ^{a} represents a probability that a heel strike occurred at time t based on audio analysis;
σₐ² represents a variance of an acoustical determination of heel strikes;
heel-strikeₜ^{m} represents a probability that a heel strike occurred at time t based on motion analysis; and
σₘ² represents a variance of a motion determination of heel strikes.

7. The device of claim 1, wherein the device is a cell phone and the particular condition is whether a user's mouth and/or ear is within a predetermined distance of the cell phone.

8. The device of claim 1, wherein the device is a cell phone and the particular condition is whether the cell phone is located in a particular location within a vehicle.

9. The device of claim 1, wherein the device is an actigraphy device and the particular condition is sleep level of the user.

10. The device of claim 1, wherein the device is a fall detection device and the particular condition is whether the user has fallen.

11. A method comprising:
sensing motion of a user and generating at least one motion output;
sensing sounds in a vicinity of the user and generating at least one audio output; and
determining whether a particular condition associated with the user is met using both the at least one motion output and the at least one audio output.

12. The method of claim 11, further comprising:
decomposing an audio scene, based on the at least one audio output, into component audio elements which are each associated with a different audio source proximate the user, and
adjusting at least one of the component audio elements using the at least one motion output.

13. The method of claim 11, further comprising:
decomposing a motion scene, based on the at least one motion output, into component motion elements; and
adjusting at least one of the component motion elements using the at least one audio output.

14. The method of claim 11, wherein the particular condition is whether the user has taken a step.

15. The method of claim 14, further comprising:
determining a value associated with a probability that the step has occurred based on both the at least one motion output and the at least one audio output.

16. The method of claim 15, wherein the step of determining the value associated with the probability that the step has occurred is performed by calculating:
$$( \frac{\frac{1}{{σ}_{a}^{2}}}{\frac{1}{{σ}_{a}^{2}} + \frac{1}{{σ}_{m}^{2}}} ) heel \text{-} {strike}_{t}^{a} + ( \frac{\frac{1}{{σ}_{m}^{2}}}{\frac{1}{{σ}_{a}^{2}} + \frac{1}{{σ}_{m}^{2}}} ) heel \text{-} {strike}_{t}^{m}$$
where:
heel-strikeₜ^{a} represents a probability that a heel strike occurred at time t based on audio analysis;
σₐ² represents a variance of an acoustical determination of heel strikes;
heel-strikeₜ^{m} represents a probability that a heel strike occurred at time t based on motion analysis; and
σₘ² represents a variance of a motion determination of heel strikes.

17. The method of claim 11, wherein the particular condition is whether the user's mouth and/or ear is within a predetermined distance of a cell phone that the user is holding.

18. The method of claim 11, wherein the particular condition is whether the user's cell phone is located in a particular location within a vehicle.

19. The method of claim 11, the particular condition is sleep level of the user.

20. The method of claim 11, wherein the device is a fall detection device and the particular condition is whether the user has fallen.

21. A communication device comprising:
at least one microphone;
at least one motion sensor;
at least one wireless transceiver; and
at least one processor;
wherein the at least one processor and the at least one wireless transceiver are configured to transmit voice signals received from the at least one microphone over an air interface;
wherein the at least one processor is further configured to receive audio data from the at least one microphone and motion data from the at least one motion sensor and uses both the audio data and the motion data to adapt processing of the voice signals for transmission.

22. The communication device of claim 21, wherein the at least one processor uses the audio data and the motion data to determine a proximity of a user's mouth to the at least one microphone and uses the proximity to adapt the processing of the voice signals.

23. The communication device of claim 22, wherein the at least one processor adapts amplification of the voice signals as a function of the determined proximity.

24. A system comprising:
at least one sensor for sensing motion of said device and generating at least one motion output;
at least one sensor for sensing sounds in a vicinity of the device and generating at least one audio output;
a processor adapted to determine whether a particular condition associated with the device or a user of the device is met using both the at least one motion output and the at least one audio output.

25. The system of claim 24, wherein the processor, the at least one sensor for sensing motion and the at least one sensor for sensing sounds are all disposed in a same device.

26. The system of claim 24, wherein at least two of: the processor, at least one sensor for sensing motion and the at least one sensor for sensing sounds, are disposed in a different devices.

27. The device of claim 1, wherein the processor is further adapted to determine whether the particular condition associated with the device or the user of the device is met by combining the at least one motion output and the at least one audio output using Kalman filtering or Maximum Likelihood.
